(19) United States
(12) Patent Application Publication
(10) Pub. No.: US 2023/0229995 A1
(43) Pub. Date: Jul. 20, 2023

(54) VIRTUAL POWER PLANT SYSTEM FOR CURTAILING POWER USAGE OF VARIOUS ASSETS

(71) Applicant: Zome Energy Networks, Inc., San Francisco, CA (US)

(72) Inventors: Alex Papalexopoulos, San Francisco, CA (US); Shmuel Oren, Berkeley, CA (US)

(21) Appl. No.: 18/155,522

(22) Filed: Jan. 17, 2023

Related U.S. Application Data
(60) Provisional application No. 63/266,783, filed on Jan. 14, 2022.

(51) Int. Cl. G06Q 10/0631; G06Q 50/06

(52) U.S. Cl. CPC G06Q 10/06312; G06Q 50/06

(57) ABSTRACT

A virtual power plant manages power consumption of various assets and curtails the power consumption of the assets based, at least in part, on power consumption flexibility of the assets. Curtailing the power consumption of the assets reduces electricity required which is effectively the same as generating electricity. The electricity that has been reduced by the curtailment may be subsequently resold on the wholesale market.

### CROSS-REFERENCE TO RELATED APPLICATION

This application a non-provisional application of, and claims priority to, U.S. Provisional Application No. 63/266,783, filed on Jan. 14, 2022 and entitled Demand-Supply Virtual Power Delivery System, the entire disclosure of which is hereby incorporated by reference it its entirety.

### FEDERALLY ENDORSED RESEARCH

The invention was made with government support under ETA Cooperative Agreement No. DE-AR0001281 awarded by the Department of Energy Advanced Research Projects AR-1. The government has certain rights in the invention

### BACKGROUND

Electricity is sold, bought, and traded in wholesale markets and retail markets. Typically, a wholesale market for electricity is one in which electricity is purchased and sold to resellers. The resellers subsequently sell the electricity to another entity in retail markets. Currently, small assets (e.g., internet of things (IOT) devices) at the end of a power grid are essentially invisible to the wholesale market as these assets are primarily seen as assets that consume power.

Accordingly, it would be beneficial for a system to manage the power consumption of these small assets and enable electricity that is not consumed by these small assets to be sold on the wholesale market.

### SUMMARY

The present application describes a system that manages power consumption of various assets and curtails the power consumption of the assets based, at least in part, on power consumption flexibility of the assets. In some examples, if the power consumption of the assets can be curtailed or reduced, the electricity that is saved/reduced may be subsequently resold on the wholesale market. For example, if 1 megawatt of electricity is saved by curtailing power usage of the assets, the 1 megawatt of electricity is effectively considered as having been generated and may subsequently be sold.

Accordingly, the present application describes a virtual power plant system that identifies a number of assets that are effectively invisible to a power grid. The assets may be internet of things (IOT) devices such as, for example, appliances, thermostats, water heaters and other such devices. The assets may also be electricity generators such as, for example, solar panels, batteries and the like. The virtual power plant system described herein may determine market conditions of an electricity wholesale market and determine, based on a risk-analysis algorithm, how much electricity can be curtailed and subsequently offered to the electricity wholesale market. If the offer is accepted, the virtual power plant generates instructions to curtail the usage of electricity by the assets.

Accordingly, the present application describes a method for managing power consumption for various assets. In an example, the method includes receiving capacity information for a plurality of assets. The method also includes receiving information regarding a demand for a resource (e.g., electricity) consumed (or produced) by each asset of the plurality of assets. A determination is made based, at least in part, on one or more factors associated with the plurality of assets, regarding a probability of curtailing usage of the resource consumed by each asset of the plurality of assets. Based on determining the probability of curtailing usage of the resource, resource curtailment information (e.g., an offer) is generated and subsequently provided to a computing device associated with an entity (e.g., an electricity market).

The present application also describes a system, comprising at least one processor and a memory communicatively coupled to the at least one processor. The memory stores instructions that, when executed by the at least one processor, perform operations. In an example, the operations include receiving capacity information for a plurality of assets. Information regarding a demand for a resource consumed by each asset of the plurality of assets may also be received. A determination is then made based at least in part, on one or more factors associated with the plurality of assets, regarding a probability of curtailing usage of the resource consumed by each asset of the plurality of assets. Based on determining the probability of curtailing usage of the resource, resource curtailment information is generated.

Also described is a method for managing power consumption for various assets. In an example, the method includes determining whether a probability of curtailing electricity usage of one or more devices has been accepted by an entity. In an example, the probability is based, at least in part, on a reliability of one or more assets of the various assets, characterizations associated with the one or more assets, and a penalty for not providing a specified amount of electricity. Based on this determination, resource curtailment instructions are generated and provided to the one or more assets.

This summary is provided to introduce a selection of concepts in a simplified form that are further described below in the Detailed Description. This summary is not intended to identify key features or essential features of the claimed subject matter, nor is it intended to be used to limit the scope of the claimed subject matters.

### BRIEF DESCRIPTION OF THE DRAWINGS

Non-limiting and non-exhaustive examples are described with reference to the following Figures.

FIG. 1A illustrates an example system for managing power consumption of a number of assets according to an example.

FIG. 1B illustrates how curtailment instructions are provided to the assets of FIG. 1A in order to curtail power consumption based on an offer provided to a market according to an example.

FIG. 2 illustrates a method for managing power consumption of one or more assets according to an example.

FIG. 3 is a system diagram of a computing device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As discussed above, examples of the present application describe a system that manages power consumption of various assets. In examples, the assets may be essentially invisible to a power grid. That is, the assets may be devices that primarily utilize electricity. However, if the power consumption of the assets can be curtailed or reduced, the electricity that is saved may be subsequently resold on the wholesale market. For example, if the assets utilize two megawatts of electricity and the system can effectively curtail use of 1 megawatt of electricity, the 1 megawatt of electricity can be sold on an electricity wholesale market.

As will be described herein, the system may determine market conditions of an electricity wholesale market. Based on the market conditions, the system may determine, based on a risk-analysis algorithm, how much electricity usage of the assets can be curtailed and subsequently offered to the electricity wholesale market. If the offer is accepted, the virtual power plant generates instructions to curtail the usage of electricity by the assets.

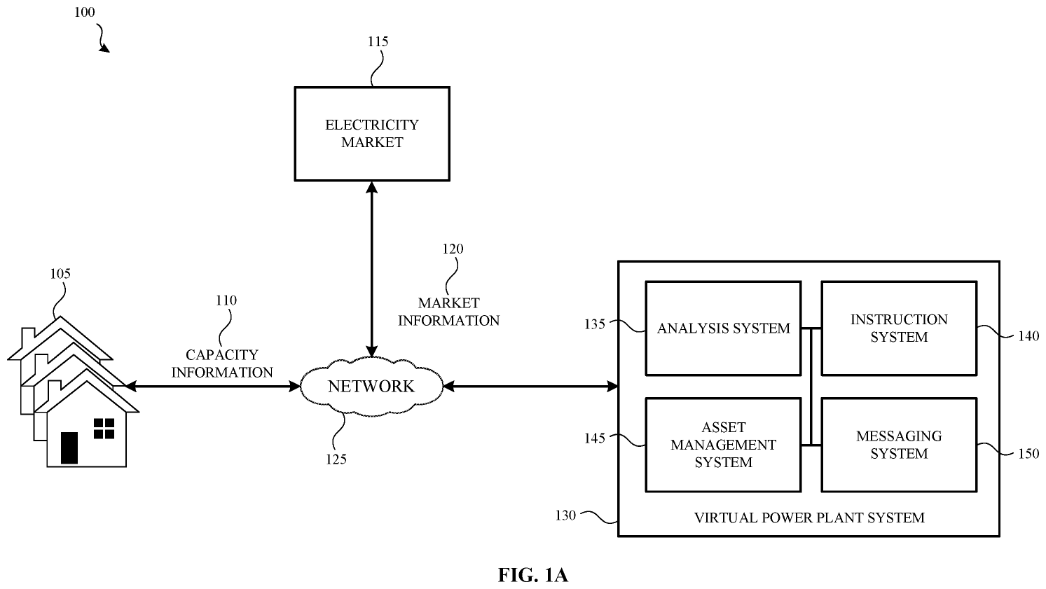

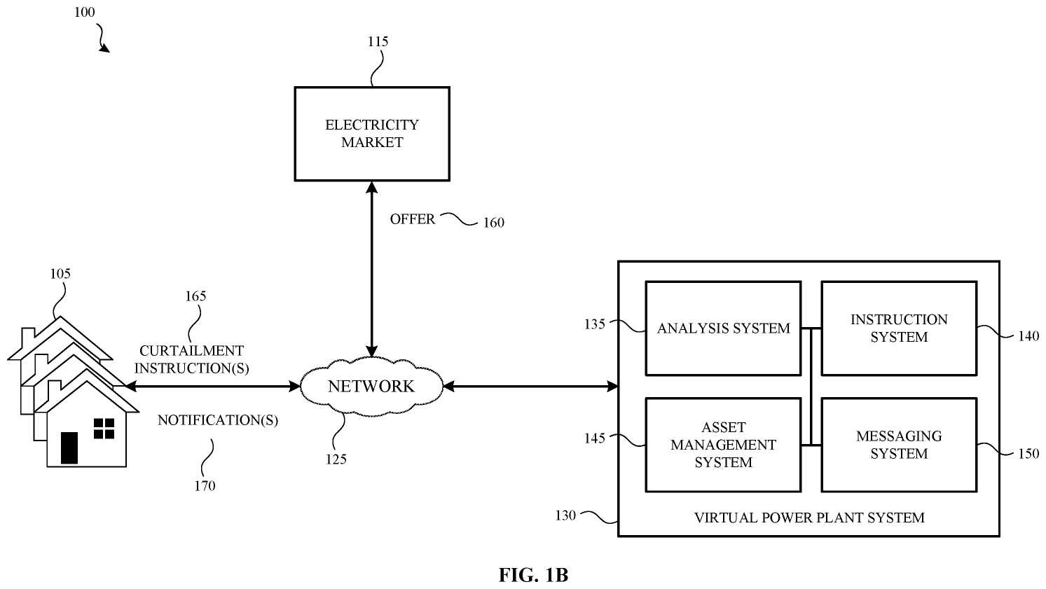

These various benefits and examples will be described in greater detail below with reference to FIG. 1A-FIG. 3.

FIG. 1A illustrates an example system 100 for managing power consumption of a number of assets 105 according to an example. In an example, the system 100 includes a virtual power plant system 130 that manages power (e.g., electricity) consumption of the assets 105. Any power that is saved by, for example, curtailing power consumption of the assets 105, may be subsequently made available (e.g., in the form an offer 160 (FIG. 1B)) to an electricity market 115. In some examples, the offer 160 is in the form of a monotonically increasing or decreasing curve.

In the example shown in FIG. 1A, the virtual power plant system 130 includes an analysis system 135, an instruction system 140, an asset management system 145 and a messaging system 150. Each of these sub-systems of the virtual power plant system 130 will be described in greater detail herein.

In some examples, the assets 105 may be structures (e.g., homes, buildings) that have in them various devices that consume electricity. For example, each structure may include thermostats and/or associated HVAC systems, hot water heaters, electric ovens, pool pumps, pond pumps, electric vehicle chargers, and other devices that typically consume or otherwise use electricity. In another example, the assets 105 may be the devices themselves. In some examples, the devices may be internet of things (IOT) devices that are able to connect (either directly or indirectly) to a network 125. Although the assets 105 mentioned herein are devices that consume electricity, it is also contemplated that the assets 105 may provide or otherwise generate electricity. These assets 105 may include, but are not limited to, solar panels, residential wind turbines, geothermal systems, electric battery systems, and the like.

As briefly mentioned above, the system 100 includes a virtual power plant system 130. The virtual power plant system 130 may be configured to monitor power consumption (and/or the generation of electricity, based on the capabilities of the assets 105) of the assets 105. In some examples, the virtual power plant system 130 may be communicatively coupled to the assets 105 via a network 125. Although a network 125 is shown and described, the virtual power plant system 130 may be communicatively coupled to the assets 105 via another communication channels such as, for example, Ethernet, WiFi, LoraWAN, Bluetooth, infrared and other such communication channels.

The virtual power plant system 130 may also be communicatively coupled (e.g., via the network 125) to an electricity market 115. In an example, the electricity market 115 is a wholesale electricity market in which electricity is purchased and sold to retail energy providers. The electricity market 115 may provide market information 120 to the virtual power plant system 130.

As shown in FIG. 1A, the market information may be provided to the virtual power plant system 130 via the network 125. The market information 120 may be information regarding the current (or anticipated) selling price of electricity in a wholesale market (e.g., electricity market 115). In an example, the market information 120 may be received by or otherwise provided to the virtual power plant system 130 in response to a request submitted by the virtual power plant system 130. The market information120 may be provided periodically, in real time or in substantially real time. For example, the virtual power plant system 130 may request market information 120 from the electricity market 115 every thirty minutes, every hour, every two hours, every day, etc.

When the market information 120 is received, the virtual power plant system 130 may determine, based on a risk analysis algorithm, an amount of electricity that can be “delivered” to the electricity market 115. In an example, the amount of electricity that is delivered to the electricity market 115 is equivalent or substantially equivalent to an amount of electricity that may be curtailed from the assets 105 during a specified period of time. For example, if the virtual power plant system 130 is able to curtail usage of one megawatt of electricity from the assets 105, the curtailment of one megawatt of electricity it is mathematically equivalent to the virtual power plant system 130 producing or otherwise generating one megawatt of electricity.

Thus, although the assets 105 may not specifically generate electricity, the virtual power plant system 130 is able to “generate” electricity based on the curtailment of electricity usage of the assets 105 and provide an offer of curtailment to the electricity market 115.

In an example, the curtailment offer (also referred to herein as offer 160 (FIG. 1B) is based on a number of factors. These factors may include but are not limited to, the market information 120, a confidence level that the virtual power plant system 130 can curtail electricity usage of the assets 105 by the offered amount and/or an amount of risk the virtual power plant system 130 is willing to assume (e.g., based on the market information, a penalty for not providing or otherwise curtailing an amount of electricity specified in the offer) and/or an amount of revenue for selling the “generated” electricity. For example, if the virtual power plant system 130 determines, based on the factors indicated above, that it can curtail X amount of electricity usage and make Y amount of revenue, the virtual power plant system 130 may generate an offer. However, the offer may be increased or decreased based, at least in part, on a confidence level that the virtual power plant system 130 can actually curtail the usage of electricity, and includes potential penalties for not providing the offered electricity and/or an inconvenience factor (e.g., will users of the assets be overly inconvenienced if the assets are turned off or otherwise adjusted to reduce the amount of electricity used by the assets) associated with curtailing electricity consumption of the assets.

In order to determine and subsequently provide a curtailment offer to the electricity market 115, the virtual power plant system 130 may receive or otherwise request capacity information 110 from the various assets 105. In some examples, the request for capacity information 110 may occur in response to market information 120 being received. In another example, market information is received once capacity information 110 has been received. In another example, receipt of market information 120 and/or capacity information 110 may be received at different times independent of one another.

In an example, the capacity information 110 is information related to the amount of electricity used by each of the assets 105 and/or an aggregation of the amount of electricity used by the assets 105. The capacity information 110 may also be based on a particular time frame. For example, the capacity information 110 may indicate that the assets 105 utilize 5 megawatts of electricity in a given day or other time frame.

In an example, the capacity information 110 of the assets 105 may be viewed as a controllable demand of a population of N devices or curtailable load segments with respective capacities kᵢ. In some examples, the curtailable load segments may be sorted or otherwise ordered based, at least in part, on a curtailment priority, a reliability and/or asset characteristics (explained in greater detail below). Additionally, the energy yield of each asset 105 or curtailable load segment may be a random variable xᵢ ∈ [0, kᵢ] with a probability distribution fᵢ(xᵢ).

The capacity information 110 may also include usage information about the various assets 105. The usage information may include information regarding the type of asset/device (e.g., whether the asset/device is an appliance, a thermostat, a battery, a solar panel, etc.), an amount of electricity consumed (or generated) during a particular time period and/or the reliability of the asset.

In an example, the reliability of the asset includes information regarding whether the device can be shut down or suspended at any time, whether the device can be shut down or suspended at particular times (e.g., during times of peak power consumption), whether the device can be shut down or suspended only in cases of emergency, and/or whether the device cannot be shut down or suspended. The reliability of the asset may also include information regarding whether one or more operating parameters of the asset can be adjusted. For example, if the asset 105 is a thermostat that is set to cool a home to 70 degrees, the operating parameter (e.g., the temperature set-point or otherwise specified by the thermostat) may be automatically adjusted (e.g., set to cool the home only to 74 degrees) during a particular time period or time periods.

In an example, the capacity information 110 is provided to the virtual power plant system 130 via the network 125. When the capacity information 110 is received, the capacity information 110 is provided to an analysis system 135 of the virtual power plant system 130. In an example, the analysis system 135 may also receive the market information 120.

FIG. 1B illustrates how curtailment instructions 165 are provided to the assets 105 of FIG. 1A in order to curtail power consumption based on an offer 160 provided to a market (e.g., the electricity market 115) according to an example. For example, upon on receiving the capacity information 110 and/or the market information 120, the analysis system 135 determines, based on a risk-analysis algorithm, an offer 160 that is to be provided to the electricity market 115. The risk analysis algorithm may include sorting the assets 105 based on a curtailment priority. The curtailment priority may be based, at least in part, on subscribed priority tranches of aggregated devices, curtailment cost per kilowatt with explicit or implicit valuation υᵢ per kilowatt of curtailed capacity which is monotonically increasing in i. In an example, at a given point in time, energy yield from curtailing assets {1, . . . I} with total capacity K_{I}=Σᵢ₌₁^{I} kᵢ is X_{I}=Σᵢ₌₁^{I} xᵢ. A total yield factor for dispatching {1, . . . I} devices is a random variable Y_{I}=X_{I}/K_{I} with cumulative probability distribution P(Y_{I}) which can be computed based on data received from one or more of the assets 105.

In some examples and as part of determining the energy yield of curtailed assets 105, the analysis system 135 may group or aggregate the assets 105 based, at least in part, on the reliability of each asset 105 or other characterizations (age of the device, amount of electricity consumed or produced by the asset, potential energy savings by adjusting an operating state of the of the assets 105). In some examples, grouping or aggregating the assets 105 enables the analysis system 135 to probabilistically determine which assets 105 will be (or should be) curtailed (and/or an order in which the assets 105 will be curtailed) in order to provide the offered and committed electricity to the electricity market 115. For example, a yield distribution may guide the curtailment of assets 105 to deliver a specified amount of electricity with a given probability. For instance, if the analysis system 135 determines, based on the market information 120 and/or the capacity information 110 to deliver Q kilowatts with a probability of P, asset 105 capacity should be deployed such that K=Q/Y where P(Y)≥P.

The virtual power plant system 130 may also include an asset management system 145 and an instruction system 140. In an example, the instruction system 140 may generate curtailment instructions 165 that are to be provided to the assets 105 based, at least in part, on the analysis performed by the analysis system 135. For example, the analysis system 135 may determine, based on the risk-analysis algorithm described above, that the assets 105 that are currently consuming 5 megawatts of electricity a day can be curtailed such that the assets use 3 megawatts of electricity. As a result, an offer 160 (FIG. 1B) of 2 megawatts can be provided as an offer 160 to the electricity market 115.

In an example, the offer 160 may also be based on curtailment probabilities of the assets 105 and/or on assets 105 that generate or otherwise provide electricity (e.g., solar panels, batteries). For example, in the following equations, the demand reserve supply function may be represented as Q(p) where p is the market clearing price per kilowatt hour of energy reserves. Additionally, the output of assets 105 that generate electricity may be represented as a random variable S with probability distribution g(S). In such an example, the amount of electricity provided by the virtual power plant 130 may depend on the realized output of the electricity generating assets 105 and the offer 160 may be a composite of these outputs.

In an example, if the offer 160 is accepted, revenue that is expected and/or generated from the offer 160 may be represented as p·Q(p) while the cost depends on the curtailed capacity K(p). In the following equations, and for convenience, the yield is a direct function of deployed capacity (e.g.,

$$Y ( K ) = {Y}_{{I}_{∈ \{ K = {K}_{I} \}}} )$$

and the total deployment cost is a function of the deployed capacity (e.g., V(K)=Σᵢ₌₀^{I∉{K}^{_{I}}^{=K}}υᵢ·kᵢ). If the virtual power plant 130 cannot deliver the electricity provided in the offer 160, a penalty h will be assessed. The supply function and the corresponding deployed capacity should maximize the expected net revenue with respect to Q and K on the market clearing price p. This is represented by the following equation:

Max_{K,Q} [E_{S,Y(K(p))}{p·Q(p)−V(K(p)+h·[K(p)·Y(K(p))+S−Q(p)]⁻=Max_{K,Q}{p·Q(p)−V(K(p)+h·[K(p)·Y̅(K(p))+S̅−Q(p)]

In an example, a maximum K occurs when Y̅(K(p))·K(p)+S̅=Q(p). As such, the optimal supply function may be achieved when p·[Y̅(K(p))·K(p)+S̅]−V(K(p)) is maximized. The maximization occurs occurs when p·Y̅(K(p))=V′(K(p) (e.g., the market clearing price scaled by the expected yield equals the marginal valuation, or the valuation of the most valuable curtailed capacity). Accordingly, the analysis system may determine the total capacity curtailment as function of wholesale price K*(p). Additionally, the corresponding supply function is represented by Q*(p)=Y̅(K*(p))·K*(p)+S̅.

In order to achieve the electricity savings specified in the offer 160, the instruction system 140, either alone or in conjunction with the analysis system 135, generates curtailment instructions 165 (FIG. 1B). The curtailment instructions 165 include instructions regarding operating parameters that are to be adjusted, whether certain assets 160 should be powered down based on, for example, the reliability of the asset 105 and so on.

Once generated, the curtailment instructions 165 may be provided to the asset management system 145. The asset management system 145 may then cause the curtailment instructions 165 to be provided to the assets 105. In another example, the asset management system 145 causes each of the assets 105 to execute the curtailment instructions. The asset management system 145 may also monitor the status of each asset 105 with respect to the curtailment instructions 165 to help ensure the asset 105 is executing the curtailment instructions and/or manifesting the anticipated or expected electricity savings during curtailment.

The virtual power plant system may also include a messaging system 150. The messaging system may generate and/or provide one more notifications 170 to the assets 105 and/or to computing devices associated with one or more owners of the assets 105. In an example, the notifications 170 may provide information regarding which assets 105 were (or will be) curtailed, an estimated time of curtailment, and/or an estimated duration of the curtailment.

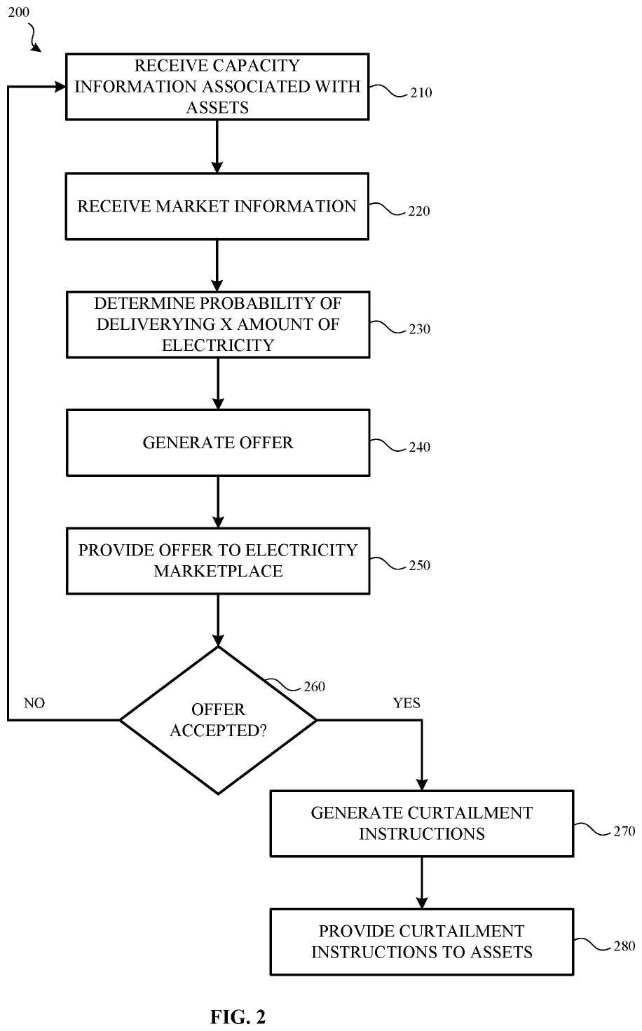

FIG. 2 illustrates a method 200 for managing power consumption of one or more assets according to an example. The method 200, or portions of the method 200, may be performed by one or more sub-systems of the system 100 shown and described with respect to FIG. 1A-FIG. 1B.

In an example, method 200 begins when capacity information for one or more assets is received (210) by a virtual power plant system. In an example, the capacity information is information related to the amount of electricity used by each asset in or otherwise associated with the system. In an example, the capacity information may also be based on a particular time frame. For example, the capacity information may indicate that the assets of the system utilize X megawatts of electricity in a time period.

The capacity information may also include usage information associated with each asset of the system. In an example, the usage information may include information regarding the type of asset/device, an amount of electricity consumed (or generated) during a particular time period and/or the reliability of the asset. As previously described, the reliability of the asset includes information regarding whether the device can be shut down or suspended at any time, whether the device can be shut down or suspended at particular times, whether the device can be shut down or suspended only in cases of emergency, and/or whether the device cannot be shut down or suspended. The reliability of the asset may also include information regarding whether one or more operating parameters of the asset can be adjusted.

The method 200 also includes receiving (220) market information. In an example, the market information includes information about a wholesale electricity market. The market information may be received periodically, in real time, in substantially real time or based on changes to market conditions (e.g., cost/price of electricity).

Based on receiving the capacity information and/or the market information, the system determines (230) a probability that it can deliver X amount of electricity. As explained above, delivering X amount of electricity may be equivalent to curtailing usage of X amount of electricity by the assets associated with the system. In an example, the probability may be based on a risk-analysis algorithm that considers, among other factors, the reliability of each asset, characterizations of each asset, market information, including a penalty for not providing an amount of electricity specified in the offer, a confidence level that the virtual power plant system can curtail the usage of electricity, and/or an inconvenience factor associated with curtailing electricity consumption of the assets. The system may then generate (240) an offer and provide (250) the offer to the electricity marketplace.

In an example, a determination (250) may be made as to whether the offer is accepted. If the offer is not accepted, the method 200 may repeat. However, if the offer is accepted, the system may generate (270) curtailment instructions. The curtailment instructions may then be provided (280) to the assets such as described above.

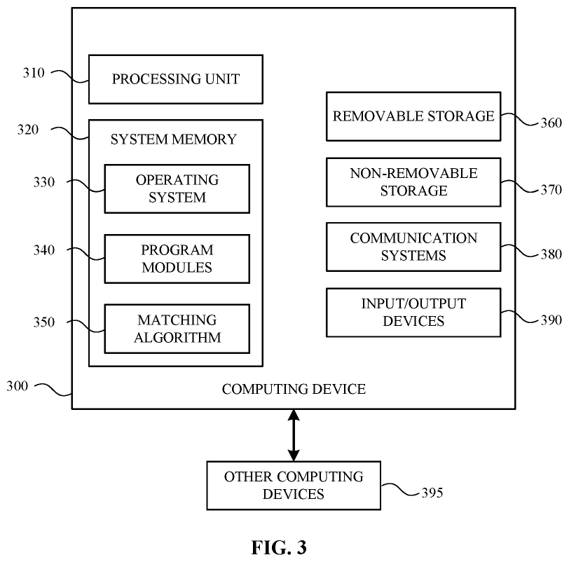

FIG. 3 is a system diagram of a computing device 300 according to an example. The computing device 300, or various components and systems of the computing device 300, may be integrated or associated with one or more systems and/or subsystems shown and described with respect to FIG. 1. For example, the computing device may be part of or otherwise integrated with the virtual power plant system 130, the analysis system 130, the instruction system 140, the asset management system 145 and/or the messaging system 150. As shown in FIG. 3, the physical components (e.g., hardware) of the computing device are illustrated and these physical components may be used to practice the various aspects of the present disclosure.

The computing device 300 may include at least one processing unit 310 and a system memory 320. The system memory 320 may include, but is not limited to, volatile storage (e.g., random access memory), non-volatile storage (e.g., read-only memory), flash memory, or any combination of such memories. The system memory 320 may also include an operating system 330 that controls the operation of the computing device 300 and one or more program modules 340. The program modules 340 may be responsible for executing and/or determining a matching algorithm 350. A number of different program modules and data files may be stored in the system memory 320. While executing on the processing unit 310, the program modules 340 may perform the various processes described above.

The computing device 300 may also have additional features or functionality. For example, the computing device 300 may include additional data storage devices (e.g., removable and/or non-removable storage devices) such as, for example, magnetic disks, optical disks, or tape. These additional storage devices are labeled as a removable storage 360 and a non-removable storage 370.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 3 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 300 on the single integrated circuit (chip). The disclosure may also be practiced using other technologies capable of performing logical operations such as, for example, AND, OR, and NOT, including but not limited to mechanical, optical, fluidic, and quantum technologies.

The computing device 300 may include one or more communication systems 380 that enable the computing device 300 to communicate with other computing devices 395 such as, for example, routing engines, gateways, signings systems and the like. Examples of communication systems 380 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 300 may also have one or more input devices and/or one or more output devices shown as input/output devices 390. These input/output devices 390 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 320, the removable storage 360, and the non-removable storage 370 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 300. Any such computer storage media may be part of the computing device 300. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The term computer-readable media as used herein may include computer storage media. Computer storage media may include volatile and nonvolatile, removable and non-removable media implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by a computing device (e.g., host device 102 (FIG. 1)). Any such computer storage media may be part of the computing device. Computer storage media does not include a carrier wave or other propagated or modulated data signal.

Additionally, examples described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various examples.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks. Additionally, it is contemplated that the flowcharts and/or aspects of the flowcharts may be combined and/or performed in any order.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. A method for managing power consumption for various assets, comprising:
receiving capacity information for a plurality of assets;
receiving information regarding a demand for a resource consumed by each asset of the plurality of assets;
determining, based at least in part, on one or more factors associated with the plurality of assets, a probability of curtailing usage of the resource consumed by each asset of the plurality of assets;
based on determining the probability of curtailing usage of the resource, generating resource curtailment information; and
providing the resource curtailment information to a computing device associated with an entity.

2. The method of claim 1, wherein the resource is electricity.

3. The method of claim 1, further comprising determining whether the resource curtailment information is accepted.

4. The method of claim 3, further comprising generating curtailment instructions for at least one asset of the plurality of assets based, at least in part, on the resource curtailment information being accepted.

5. The method of claim 4, further comprising providing the curtailment instructions to the at least one asset.

6. The method of claim 5, further comprising periodically monitoring the at least one asset to determine whether the at least one asset is adhering to the curtailment instructions.

7. The method of claim 1, wherein the plurality of assets are Internet of Things devices.

8. A system, comprising:
at least one processor; and
a memory communicatively coupled to the at least one processor and storing instructions that, when executed by the at least one processor, perform operations, comprising:
receiving capacity information for a plurality of assets;
receiving information regarding a demand for a resource consumed by each asset of the plurality of assets;
determining, based at least in part, on one or more factors associated with the plurality of assets, a probability of curtailing usage of the resource consumed by each asset of the plurality of assets; and
based on determining the probability of curtailing usage of the resource, generating resource curtailment information.

9. The system of claim 8, further comprising instructions for providing the resource curtailment information to a computing device associated with an entity.

10. The system of claim 8, further comprising instructions for determining whether the resource curtailment information is accepted.

11. The system of claim 8, further comprising instructions for generating curtailment instructions for at least one asset of the plurality of assets based, at least in part, on the resource curtailment information being accepted.

12. The system of claim 11, further comprising instructions for providing the curtailment instructions to the at least one asset.

13. The system of claim 12, further comprising instructions for periodically monitoring the at least one asset to determine whether the at least one asset is adhering to the curtailment instructions.

14. The system of claim 8, wherein the plurality of assets are communicatively coupled to a network.

15. The system of claim 8, wherein the probability is based, at least in part, on one or more of the plurality of assets generating the resource.

16. A method for managing power consumption for various assets, comprising:
determining whether a probability of curtailing electricity usage of one or more devices has been accepted by an entity, the probability being based, at least in part, on a reliability of one or more assets of the various assets, characterizations associated with the one or more assets, and a penalty for not providing a specified amount of electricity;
based on the determining, generating resource curtailment instructions; and
providing the resource curtailment instructions to the one or more assets.

17. The method of claim 16, further comprising periodically monitoring the one or more assets to determine whether the one or more assets are adhering to the resource curtailment instructions.

18. The method of claim 16, wherein the probability is further based, at least in part, on market information associated providing electricity.

19. The method of claim 16, further comprising providing a notification to a computing device associated an individual that is associated with the one or more assets.

20. The method of claim 19, wherein the notification includes information regarding the curtailment instructions provided to the one or more assets.
